(19) United States
(12) Patent Application Publication
(10) Pub. No.: US 2025/0149708 A1
(43) Pub. Date: May 8, 2025

(54) BATTERY PACK AND METHOD OF MANUFACTURING THE SAME

(71) Applicant: SAMSUNG SDI CO., LTD., Yongin-si (KR)

(72) Inventor: Myung Hyun PARK, Suwon-si (KR)

(21) Appl. No.: 18/645,476

(22) Filed: Apr. 25, 2024

(30) Foreign Application Priority Data
Nov. 2, 2023 (KR) 10-2023-0150371

(51) Int. Cl. H01M 50/242; H01M 50/204; H01M 50/227

(52) U.S. Cl. CPC H01M 50/242; H01M 50/204; H01M 50/227

(57) ABSTRACT

A battery pack, and a method of manufacturing the same battery pack, including a cell carrier holding an array of battery cells; a frame coupled to the cell carrier; a stud coupled to the cell carrier and passing through the frame; and a coupling portion coupling the frame to the stud.

### CROSS-REFERENCE TO RELATED APPLICATION

The present application claims priority and the benefit of Korean Patent Application No. 10-2023-0150371, filed on Nov. 2, 2023 in the Korean Intellectual Property Office, the entire disclosure of which is incorporated herein by reference.

### BACKGROUND

### 1. Field

Embodiments relate to a battery pack and a method of manufacturing the same.

### 2. Description of the Related Art

In general, with rapidly increasing demand for portable electronics, e.g., laptops, video cameras, and mobile phones, and commercialization of robots and electric vehicles, research is being actively carried out to develop high-performance secondary batteries enabling repeated charging/discharging.

The above information disclosed in this Background section is provided for enhancement of understanding of the background of the present disclosure, and, therefore, it may contain information that does not constitute related (or prior) art.

### SUMMARY

Embodiments are directed to a battery pack including a cell carrier holding an array of battery cells; a frame coupled to the cell carrier; a stud coupled to the cell carrier and passing through the frame; and a coupling portion coupling the frame to the stud.

The frame may include a first frame covering a first edge of the cell carrier and coupled to the stud; and a second frame covering a second edge of the cell carrier and coupled to the first frame.

The first frame may include a pair of first frames covering a first pair of opposite edges of the cell carrier, the second frame may include a pair of second frames covering a second pair of opposite edges of the cell carrier, and the first frame and the second frame may partially overlap each other.

The coupling portion may include a first coupling portion coupling the first frame to the stud; and a second coupling portion coupling the first frame to the second frame.

The first frame may include a first frame body covering a first side surface of the cell carrier; a first frame extension extending from the first frame body and covering a second side surface of the cell carrier; and a first frame hole in the first frame body.

The second frame may include a second frame body covering the second side surface of the cell carrier and coupled to the first frame extension; and a second frame extension extending from the second frame body and coupled to the first frame body.

The second frame may further include a second frame hole at an end of the second frame extension.

The cell carrier and the stud may be integral with each other.

The stud may include a metal material and may be integral with the cell carrier, and the cell carrier may include a resin material.

The stud may include a stud contact portion; and a protrusion portion.

The stud may include a stud insert portion insert-molded into the cell carrier; a stud coupling portion extending from the stud insert portion, exposed outside the cell carrier, and coupled to the frame; and a stud penetrating portion extending from the stud coupling portion and passing through the frame.

The stud insert portion may include an insert embedded portion embedded in the cell carrier; and an insert hole portion in the insert embedded portion.

The battery pack may further include a cushioning material between the cell carrier and the frame.

Embodiments are directed to a battery pack manufacturing method including an insert molding step in which a cell carrier and a stud are formed by insert molding; a first coupling step in which the stud is coupled to a first frame covering a first side surface of the cell carrier; and a second coupling step in which the first frame is coupled to a second frame covering a second side surface of the cell carrier.

The first coupling step may include a first moving step in which the first frame is moved such that a stud penetrating portion of the stud passes through the first frame; a first close-contact step in which the first frame is brought into close contact with a stud coupling portion of the stud; and a first joining step in which the first frame is joined to the stud.

The second coupling step may include a second close-contact step in which the second frame is brought into close contact with the first frame without interference with the stud; and a second joining step in which the first frame is joined to the second frame.

The battery pack manufacturing method may further include a cushioning step in which a cushioning material is disposed between the cell carrier and the first frame.

### BRIEF DESCRIPTION OF DRAWINGS

Features will become apparent to those of skill in the art by describing in detail exemplary embodiments with reference to the attached drawings in which:

FIG. 1 is a schematic top view of a battery pack according to one embodiment of the present disclosure;

FIG. 2 is a schematic top view of a frame according to one embodiment of the present disclosure;

FIG. 3 is a schematic exploded perspective view of the frame according to the embodiment;

FIG. 4 is a schematic perspective view of the frame according to the embodiment.

FIG. 5 is a schematic view of a first frame according to one embodiment of the present disclosure;

FIG. 6 is a schematic view of a second frame according to one embodiment of the present disclosure;

FIG. 7 is a schematic view illustrating a cell carrier having a stud integrally formed therewith according to a first embodiment of the present disclosure;

FIG. 8 is a schematic view illustrating a cell carrier having a stud insert-molded thereinto according to a second embodiment of the present disclosure;

FIG. 9 is a schematic view of a stud according to the second embodiment;

FIG. 10 is a schematic view of a first coupling portion according to one embodiment of the present disclosure;

FIG. 11 is a schematic view of a second coupling portion according to one embodiment of the present disclosure;

FIG. 12 is a schematic view of a cushioning material according to one embodiment of the present disclosure;

FIG. 13 is a schematic flow diagram of a battery pack manufacturing method according to one embodiment of the present disclosure;

FIG. 14 is a schematic view illustrating a first coupling step according to one embodiment of the present disclosure;

FIG. 15 is a schematic view illustrating a second coupling step according to one embodiment of the present disclosure; and

FIG. 16 is a schematic flow diagram of a battery pack manufacturing method according to another embodiment of the present disclosure, wherein a cushioning step is added to the battery pack manufacturing method of FIG. 13.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

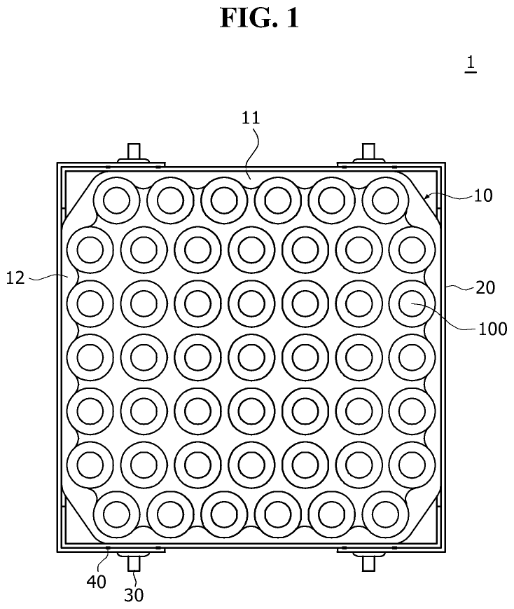

FIG. 1 is a schematic top view of a battery pack according to one embodiment of the present disclosure. Referring to FIG. 1, the battery pack 1 according to this embodiment may include a cell carrier 10, a frame 20, a stud 30, and a coupling portion 40.

The cell carrier 10 may hold an array of battery cells 100. Each battery cell 100 may have a cylindrical shape. The array of battery cells 100 may be inserted into and coupled to the cell carrier 10. The cell carrier 10 may include an insulating material, e.g., a resin material.

The frame 20 may be coupled to the cell carrier 10 to reinforce rigidity of the cell carrier 10. The frame 20 may have a shape of a rectangular band. The frame 20 may be composed of a single piece or multiple pieces joined together. The frame 20 may be formed of a metal and may cover an outer surface of the cell carrier 10. The cell carrier 10 and the frame 20 may be coupled to each other by a separate securing means.

The stud 30 may be coupled to the cell carrier 10 and may pass through the frame 20. The stud 30 may be coupled to other components in a subsequent pack assembly process. The stud 30 may be formed of a metal.

The coupling portion 40 may couple the frame 20 to the stud 30. The coupling portion 40 may be, e.g., a weld area for coupling between the frame 20 and the stud 30.

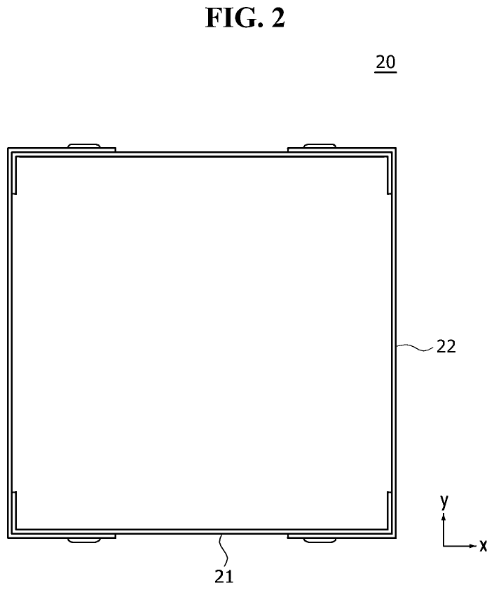

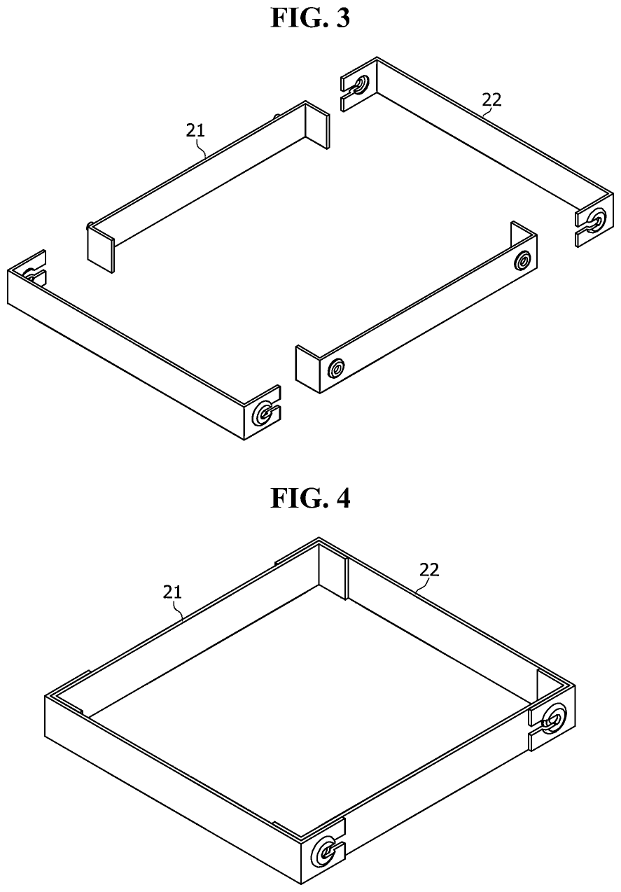

FIG. 2 is a schematic top view of the frame according to one embodiment of the present disclosure, FIG. 3 is a schematic exploded perspective view of the frame according to this embodiment, and FIG. 4 is a schematic perspective view of the frame according to this embodiment. Referring to FIG. 2 to FIG. 4, the frame 20 according to this embodiment may include a first frame 21 and a second frame 22.

The first frame 21 may cover an edge of the cell carrier 10 and may be coupled to the stud 30. The second frame 22 may cover another edge of the cell carrier 10 and may be coupled to the first frame 21.

The first frame 21 may include a pair of first frames facing each other the second frame 22 may include a pair of second frames facing each other, and the first frame 21 and the second frame 22 may partially overlap each other. For example, as illustrated in FIG. 1, the pair of first frames may cover a first pair of opposite edges of the cell carrier and the pair of second frames may cover a second pair of opposite edges of the cell carrier. Overlapping portions of the first frame 21 and the second frame 22 may be coupled to each other by welding. The first frame 21 and the second frame 22 may be disposed alternately along a perimeter of the cell carrier 10. The second frame 22 may be brought into close contact, e.g., direct contact, with the cell carrier 10 after the first frame 21 is brought into close contact with the cell carrier 10. For example, as illustrated in FIG. 4, a portion of the second frame may cover a portion of the first frame. The first frame 21 may be moved in the y-axis direction of FIG. 2 to allow the stud 30 to pass through the first frame 21. The second frame 22 may be moved in the x-axis direction of FIG. 2 to overlap the first frame 21.

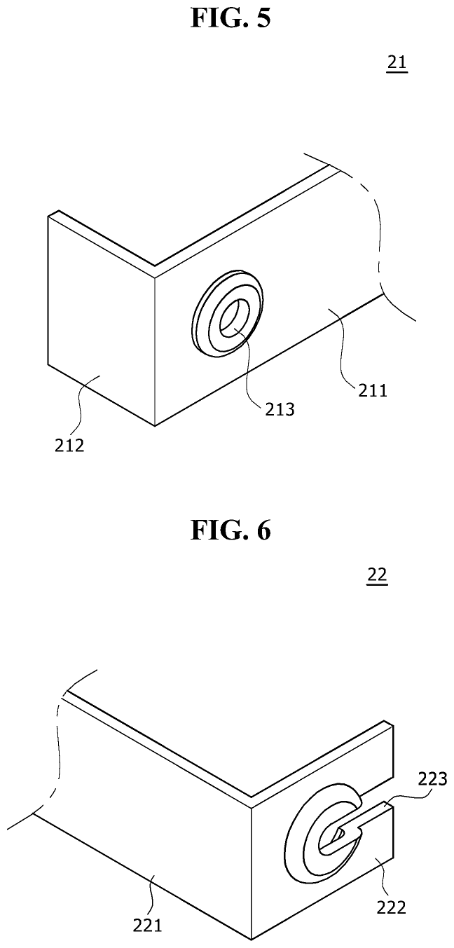

FIG. 5 is a schematic view of the first frame according to one embodiment of the present disclosure. Referring to FIG. 5, the first frame 21 may include a first frame body 211, a first frame extension 212, and a first frame hole 213.

The first frame body 211 may cover a first side surface 11 of the cell carrier 10. The first frame body 211 may correspond in length to the first side surface 11 and may face the first side surface 11. The first frame body 211 may be coupled to the cell carrier 10 by a separate securing means.

The first frame extension 212 may extend from the first frame body 211 and may cover a second side surface 12 of the cell carrier 10. The first frame extension 212 may be bent at both ends of the first frame body 211 to face a portion of the second side surface 12.

The first frame hole 213 may be formed in the first frame body 211 to allow the stud 30 to pass therethrough. The first frame hole 213 may have a size corresponding to an outer diameter of the stud 30. If the first frame body 211 is moved in the y-axis direction of FIG. 2, the first frame body 211 may be brought into close contact with the first side surface 11 after the stud 30 passes through the first frame hole 213 in the first frame body 211.

FIG. 6 is a schematic view of the second frame according to one embodiment of the present disclosure. Referring to FIG. 6, the second frame 22 may include a second frame body 221 and a second frame extension 222.

The second frame body 221 may cover the second side surface 12 of the cell carrier 10. The second frame body 221 may be coupled to the first frame extension 212. The second frame body 221 may correspond in length to the second side surface 12 and may face the second side surface 12. The second frame body 221 may be coupled to the cell carrier 10 by a separate securing means.

The second frame extension 222 may extend from the second frame body 221 and may be coupled to the first frame body 211. The second frame extension 222 may be bent at both ends of the second frame body 221 to face the first frame body 211.

The second frame 22 may further include a second frame hole 223. The second frame hole 223 may be formed in the second frame extension 222 to prevent interference with the stud 30. The second frame hole 223 may be formed at an end of the second frame extension 222 to have a predetermined length in the x-axis direction of FIG. 2. In this way, the stud 30 can be inserted into the second frame hole 223 if the second frame 22 is moved in the x-axis direction of FIG. 2 to be close to, e.g., directly on, the second side surface 12.

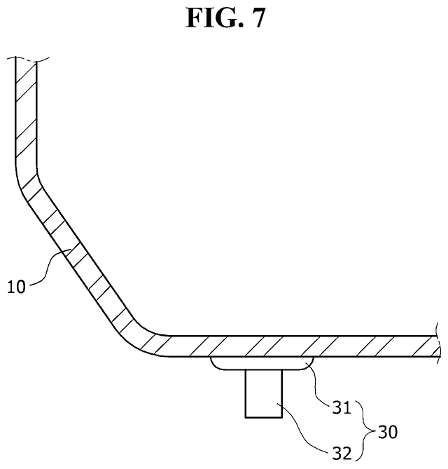

FIG. 7 is a schematic view illustrating a cell carrier having a stud integrally formed therewith according to a first embodiment of the present disclosure. Referring to FIG. 7, the cell carrier 10 and the stud 30 may be integrally formed with each other. That is, the cell carrier 10 and the stud 30 may be integrally molded using the same material, e.g., the cell carrier 10 and the stud 30 may be integral with each other to define a single, uniform, and seamless unit or structure. Both the cell carrier 10 and the stud 30 may be formed of a metal. The stud 30 according to the first embodiment may include: a stud contact portion 31 protruding from the cell carrier 10 and closely contacting the frame 20; and a stud protrusion 32 extending from the stud contact portion 31 and passing through the frame 20.

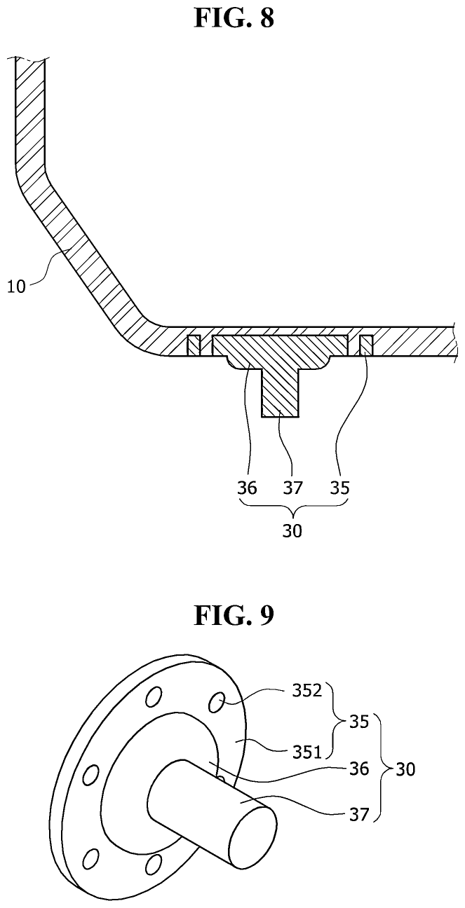

FIG. 8 is a schematic view illustrating a cell carrier having a stud insert-molded thereinto according to a second embodiment of the present disclosure, and FIG. 9 is a schematic view of the stud according to the second embodiment. Referring to FIG. 8 and FIG. 9, the stud 30 including a metal material may be integrally formed with the cell carrier 10 including a resin material by insert injection molding, e.g., the stud 30 including a metal material may be completely surrounded and embedded in the cell carrier 10 including a resin material to form a single integrated unit or structure. In an implementation, the stud 30 may include a stud insert portion 35, a stud coupling portion 36, and a stud penetrating portion 37.

The stud insert portion 35 may be insert-molded into the cell carrier 10. The stud insert portion 35 may be placed in a mold for forming the cell carrier 10 and may be covered by the cell carrier 10 during injection molding of the cell carrier 10. The stud insert portion 35 may include an insert embedded portion 351 embedded in the cell carrier 10 and an insert hole portion 352 formed in the insert embedded portion 351 which may allow the resin material forming the cell carrier 10 to pass therethrough. The insert embedded portion 351 may have a shape of a polygonal plate or a disc, and the insert hole portion 352 may include a plurality of insert hole portions equidistantly formed along the insert embedded portion 351.

The stud coupling portion 36 may extend from the stud insert portion 35, may be exposed outside the cell carrier 10, and may be coupled to the frame 20. The stud coupling portion 36 may closely contact an inner surface of the first frame body 211. The stud coupling portion 36 may have a shape of a polygonal plate or a disc that is smaller in size than the stud insert portion 35. A portion of the first frame body 211 may be recessed inside and raised outside so as to cover the stud coupling portion 36.

The stud penetrating portion 37 may extend from the stud coupling portion 36 and may pass through the frame 20. The stud penetrating portion 37 may pass through the first frame hole 213 and may be inserted into the second frame hole 223. The stud passing-through may be assembled with other components during pack assembly. For example, the stud penetrating portion 37 may pass through the frame 20 during pack assembly.

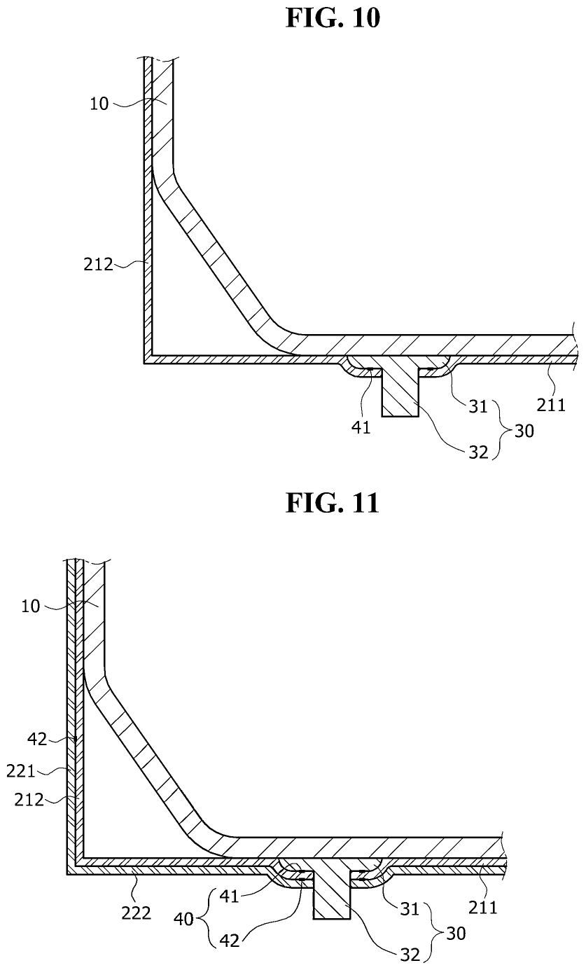

FIG. 10 is a schematic view of a first coupling portion according to one embodiment of the present disclosure, and FIG. 11 is a schematic view of a second coupling portion according to one embodiment of the present disclosure. Referring to FIG. 10 and FIG. 11, the coupling portion 40 may include a first coupling portion 41 and a second coupling portion 42. The first coupling portion 41 and the second coupling portion 42 may be a base material for joining targets to each other.

The first coupling portion 41 may couple the first frame 21 to the stud 30 by welding. In an implementation, the stud protrusion 32 according to the first embodiment or the stud coupling portion 36 according to the second embodiment may be brought into surface-to-surface contact with the first frame body 211, and the first coupling portion 41 may couple the stud protrusion 32 or the stud coupling portion 36 to the first frame body 211.

The second coupling portion 42 may couple the first frame 21 to the second frame 22 by welding. After the first frame 21 is brought into close contact with the second frame 22, overlapping portions of the first frame 21 and the second frame 22 may be welded to each other. That is, the first frame body 211 and the second frame extension 222 may be coupled to each other by welding and the first frame extension 212 and the second frame body 221 may be coupled to each other by welding.

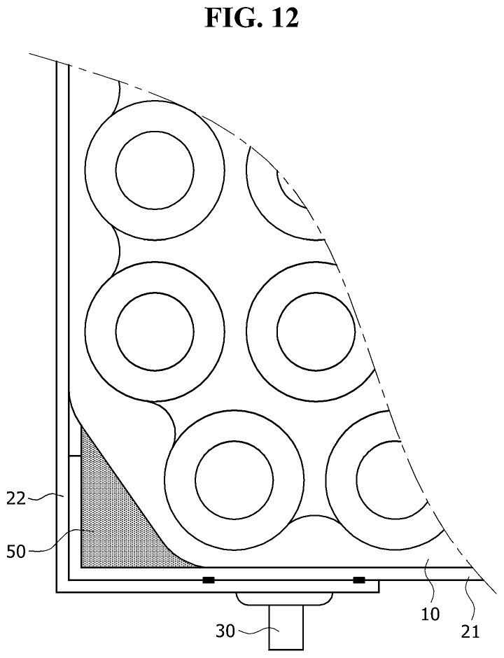

FIG. 12 is a schematic view of a cushioning material according to one embodiment of the present disclosure. Referring to FIG. 12, the battery pack 1 according to one embodiment of the present disclosure may further include a cushioning material 50.

The cushioning material 50 may be between the cell carrier 10 and the frame 20 to absorb shock. The cushioning material 50 may include an elastic damping material, e.g., rubber or sponge. The cushioning material 50 may be attached between the cell carrier 10 and the frame 20 by a bonding agent. A clearance space may be formed between each corner of the cell carrier 10 and the frame 20, and the cushioning material 50 may be inserted into the clearance space to absorb vibration or shock.

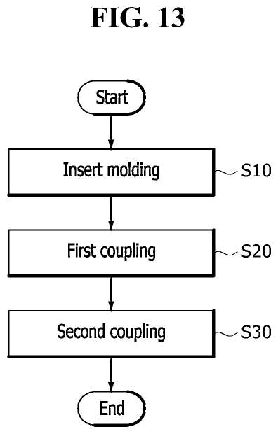

FIG. 13 is a schematic flow diagram of a battery pack manufacturing method according to one embodiment of the present disclosure. In the following, the battery pack manufacturing method according to this embodiment will be described with reference to FIG. 13.

In an insert molding step S10, a cell carrier 10 and a stud 30 are formed by insert molding. First, a portion of the stud 30 formed of a metal may be introduced into a mold for forming the cell carrier 10. After the stud 30 is introduced into the mold, a molten resin may be introduced into the mold. Then, the resin may be cured to obtain the cell carrier 10 with the stud 30 partially inserted thereinto.

In a first coupling step S20, the stud 30 may be coupled to a first frame 21 covering a first side surface 11 of the cell carrier 10. A portion of the stud 30 protruding from the cell carrier 10 may be coupled to a first frame body 211 by a first coupling portion 41.

In a second coupling step S30, the first frame 21 may be coupled to a second frame 22 covering a second side surface 12 of the cell carrier 10. The first frame 21 and the second frame 22 facing each other may be coupled to each other by a second coupling portion 42.

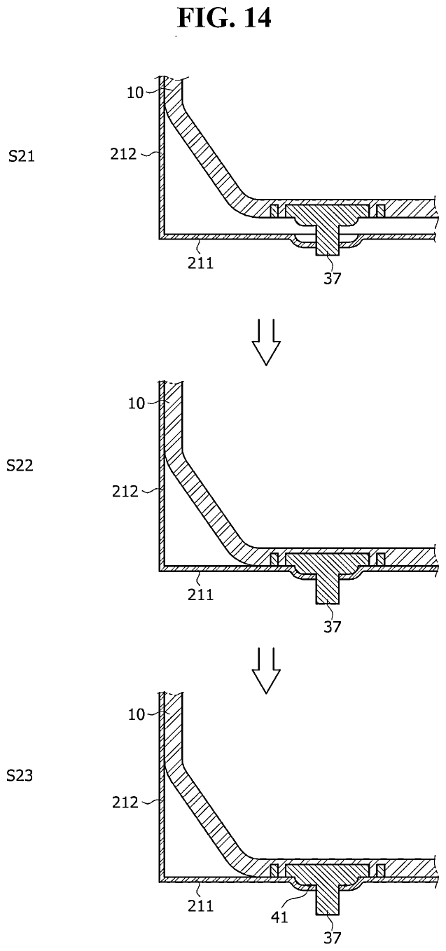

FIG. 14 is a schematic view illustrating the first coupling step according to one embodiment of the present disclosure. In the following, the first coupling step S20 will be described in detail with reference to FIG. 14. The first coupling step S20 may include a first moving step S21, a first close-contact step S22, and a first joining step S23.

In the first moving step S21, the first frame 21 may be moved such that a stud penetrating portion 37 of the stud 30 passes through the first frame 21. Since the specific configuration of the stud 30 is shown in FIG. 9, detailed description thereof will be omitted. If the first frame 21 is gripped by a transfer device such as a robot and is moved in the y-axis direction of FIG. 2, the stud 30 may pass through a first frame hole 213 formed in the first frame body 211 while remaining stationary.

In the first close-contact step S22, the first frame 21 may be brought into close contact with a stud coupling portion 36 of the stud 30. Close contact between the stud coupling portion 36 and the first frame body 211 may be detected by a separate pressure sensor or position sensor. In the case of using the pressure sensor, movement of the transfer device may be stopped if the pressure sensor detects a load applied to the transfer device upon close contact between the stud coupling portion 36 and the first frame body 211. In the case of using the position sensor, movement of the transfer device may be stopped if positions of the stud coupling portion 36 and the first frame body 211 detected in real time by the position sensor match each other. If the first frame 21 is brought into close contact with the stud coupling portion 36, the first frame body 211 may cover the first side surface 11 and a first frame extension 212 may cover a portion of the second side surface 12.

In the first joining step S23, the first frame 21 and the stud 30 may be joined to each other. In an implementation, abutting surfaces of the first frame body 211 and the stud coupling portion 36 may be joined to each other by laser spot welding. Here, a base material for welding may be disposed between the first frame body 211 and the stud coupling portion 36.

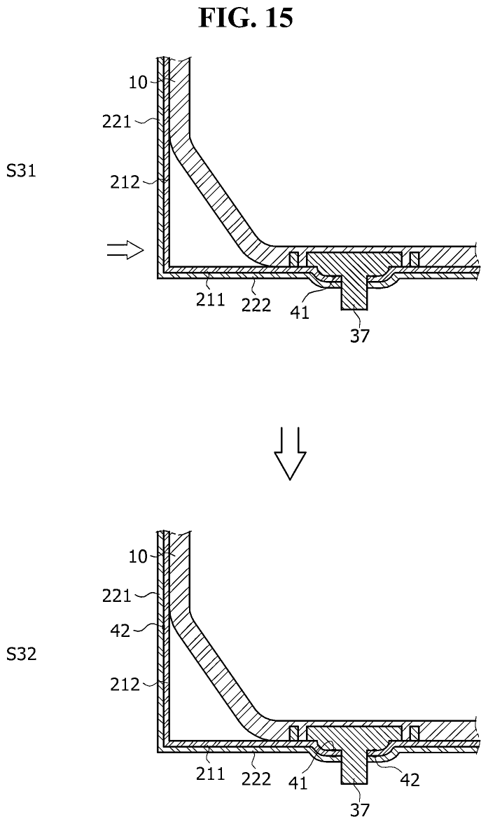

FIG. 15 is a schematic view illustrating the second coupling step according to one embodiment of the present disclosure. In the following, the second coupling step S30 will be described in detail with reference to FIG. 15. The second coupling step S30 may include a second close-contact step S31 and a second joining step S32.

In the second close-contact step S31, the second frame 22 may be brought into close contact with the first frame 21. Here, there may be no interference between the second frame 22 and the stud 30 having passed through the first frame 21. A second frame body 221 may be moved in the x-axis direction of FIG. 2 to be brought into surface-to-surface contact with the first frame extension 212. As the stud penetrating portion 37 may be inserted into a second frame hole 223 formed in a second frame extension 222, smooth movement of the second frame body 221 may be achieved. The second frame extension 222 may be brought into surface-to-surface contact with the first frame body 211.

In the second joining step S32, the first frame 21 and the second frame 22 may be joined to each other. In an implementation, abutting surfaces of the first frame body 211 and the second frame extension 222 may be joined to each other by laser spot welding and abutting surfaces of the first frame extension 212 and the second frame body 221 may be joined to each other by laser spot welding. Here, a base material for welding may be disposed between the first frame body 211 and the second frame extension 222. The base material for welding may also be disposed between the first frame extension 212 and the second frame body 221.

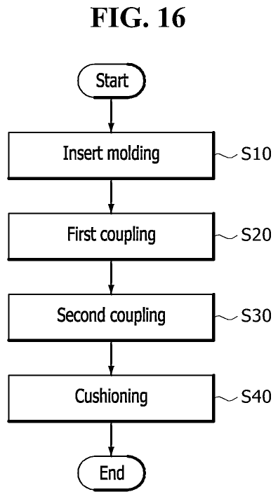

FIG. 16 is a schematic flow diagram of a battery pack manufacturing method according to another embodiment of the present disclosure, wherein a cushioning step is added to the battery pack manufacturing method of FIG. 13. Referring to FIG. 16, the battery pack manufacturing method according to this embodiment may further include a cushioning step. In the cushioning step S40, a cushioning material 50 for shock absorption may be disposed between the cell carrier 10 and the first frame 21. A transfer device, such as a robot, may grip and move the cushioning material 50 to insert the cushioning material 50 into a space between each corner of the first frame 21 and the cell carrier 10. The cushioning step S40 may be performed after the first coupling step S20.

By way of summation and review, battery packs applicable to medium to large electronic devices, e.g., notebook computers, camcorders, personal digital assistants (PDAs), and automotive batteries, may include multiple unit cells due to the limited capacity of a unit cell.

Such a battery pack may have a structure in which a large number of unit cells may be electrically connected in series or parallel. In order to ensure sequential electrical connection of the unit cells, it is very important that the unit cells maintain a stable arrangement.

In particular, cylindrical rechargeable batteries used as unit cells in battery packs may have difficulty maintaining an arrangement thereof due to the shape thereof and may thus require a separate securing device such as a cell carrier.

Vibration generated in the process of securing the cell carrier to a frame may be transferred through a stud. Here, if a securing force of the stud is insufficient, this may cause damage to products.

In the battery pack and the battery pack manufacturing method according to embodiments, a stud integrally formed with a cell carrier may pass through a frame and may be coupled to the frame, thereby suppressing vibration of the cell carrier.

In the battery pack and the battery pack manufacturing method according to embodiments, a cushioning material may be disposed between the cell carrier and the frame, thereby absorbing vibration and shock.

Embodiments may provide a battery pack in which a cell carrier and a stud are integrally formed with each other and thus ensure enhanced coupling force between the cell carrier and the frame, and a method of manufacturing the same.

A further embodiment may provide a battery pack manufactured using a battery array having an improved structure and an automobile including the same.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
a cell carrier holding an array of battery cells;
a frame coupled to the cell carrier;
a stud coupled to the cell carrier and passing through the frame; and
a coupling portion coupling the frame to the stud.

2. The battery pack as claimed in claim 1, wherein the frame includes:
a first frame covering a first edge of the cell carrier and coupled to the stud; and
a second frame covering a second edge of the cell carrier and coupled to the first frame.

3. The battery pack as claimed in claim 2, wherein:
the first frame includes a pair of first frames covering a first pair of opposite edges of the cell carrier,
the second frame includes a pair of second frames covering a second pair of opposite edges of the cell carrier, and
the first frame and the second frame partially overlap each other.

4. The battery pack as claimed in claim 2, wherein the coupling portion includes:
a first coupling portion coupling the first frame to the stud; and
a second coupling portion coupling the first frame to the second frame.

5. The battery pack as claimed in claim 2, wherein the first frame includes:
a first frame body covering a first side surface of the cell carrier;
a first frame extension extending from the first frame body and covering a second side surface of the cell carrier; and
a first frame hole in the first frame body.

6. The battery pack as claimed in claim 5, wherein the second frame includes:
a second frame body covering the second side surface of the cell carrier and coupled to the first frame extension; and
a second frame extension extending from the second frame body and coupled to the first frame body.

7. The battery pack as claimed in claim 6, wherein the second frame further includes a second frame hole at an end of the second frame extension.

8. The battery pack as claimed in claim 1, wherein the cell carrier and the stud are integral with each other.

9. The battery pack as claimed in claim 1, wherein:
the stud includes a metal material and is integral with the cell carrier, and
the cell carrier includes a resin material.

10. The battery pack as claimed in claim 1, wherein the stud includes:
a stud contact portion; and
a protrusion portion.

11. The battery pack as claimed in claim 1, wherein the stud includes:
a stud insert portion insert-molded into the cell carrier;
a stud coupling portion extending from the stud insert portion, exposed outside the cell carrier, and coupled to the frame; and
a stud penetrating portion extending from the stud coupling portion and passing through the frame.

12. The battery pack as claimed in claim 11, wherein the stud insert portion includes:
an insert embedded portion embedded in the cell carrier; and
an insert hole portion in the insert embedded portion.

13. The battery pack as claimed in claim 1, further comprising a cushioning material between the cell carrier and the frame.

14. A battery pack manufacturing method comprising:
an insert molding step in which a cell carrier and a stud are formed by insert molding;
a first coupling step in which the stud is coupled to a first frame covering a first side surface of the cell carrier; and
a second coupling step in which the first frame is coupled to a second frame covering a second side surface of the cell carrier.

15. The battery pack manufacturing method as claimed in claim 14, wherein the first coupling step includes:
a first moving step in which the first frame is moved such that a stud penetrating portion of the stud passes through the first frame;
a first close-contact step in which the first frame is brought into close contact with a stud coupling portion of the stud; and
a first joining step in which the first frame is joined to the stud.

16. The battery pack manufacturing method as claimed in claim 14, wherein the second coupling step includes:
a second close-contact step in which the second frame is brought into close contact with the first frame without interference with the stud; and
a second joining step in which the first frame is joined to the second frame.

17. The battery pack manufacturing method as claimed in claim 14, further comprising a cushioning step in which a cushioning material is disposed between the cell carrier and the first frame.
